(19) United States
(12) Patent Application Publication
(10) Pub. No.: US 2005/0240440 A1
(43) Pub. Date: Oct. 27, 2005

(54) Lexicon model and method

(76) Inventors: Frank Seidelmann, Chagrin Falls, OH (US); Peter Franklin, Newton, MA (US); Javier Beltran, New York, NY (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/110,477

(22) Filed: Apr. 20, 2005

Related U.S. Application Data
(60) Provisional application No. 60/563,686, filed on Apr. 20, 2004.

(51) Int. Cl. G06F 17/60

(52) U.S. Cl. 705/2

(57) ABSTRACT

Medical reports are a key component of a patient's medical history. Medical reports, however, often contain lexicon that is inconsistent and of insufficient detail leading to problems in analyzing the medical reports. Additionally, creating detailed medical reports can be very time consuming. The present method for creating a medical report, therefore, comprises examining at least one of a patient or test results of a patient, summarizing findings of the examination, having access to previously created phrases describing in greater detail at least one of the summarized findings, choosing at least one of the previously created phrases based upon at least one of the summarized findings, and generating a report utilizing the previously created phrases.

### CROSS-REFERENCE TO RELATED APPLICATIONS

This application claims priority from U.S. Provisional Patent Application No. 60/563,686 filed on Apr. 20, 2004, Which is hereby incorporated by reference.

### FIELD OF INVENTION

The present invention relates generally a lexicon model and method, and more particularly, to a method for creating a medical record of a patient's examination with a common lexicon regardless of the examiner.

### BACKGROUND

The medical field has a particularly complex lexicon. The complexity of this lexicon causes an array of communication problems that can lead to a significant number of problems and issues. In the interaction between doctors, patients, staff, and health insurers providing or relaying medical descriptions or interpretations can be extremely difficult. Of primary difficulty is the consistent and accurate use of medical language while also containing sufficiently complete
and clear descriptions. For example, the written descriptions contained in reports and notes of doctors vary from doctor to doctor in completeness and clarity. Such variations can occur for a number of different reasons. These include terminology used, ever-changing acceptable terminology, illegible handwriting, poor transcription or interpretation of complex phraseology, variations in regional terminology, variations in education, variations in background, etc. Clearly, fifteen different doctors could review the same information and provide fifteen different descriptions regarding a diagnosis that each provides varying degrees of clarity and completeness. This can lead to different doctors creating medical reports for patients with the same ailment that vary significantly, which could lead to wide variations in treatments.

It is important that medical reports of patients having the same ailment are substantially similar. Otherwise, many different problems can arise. For example, a doctor treating a patient for a follow-up examination may not appreciate certain aspects of a patient's ailment or the treatment that such patient previously received. This can lead to many difficulties, such as improper treatment of the patient. Another problem is that health insurers reviewing medical reports may not appreciate fully the implications thereof. This may cause inconsistent application of coverage to medical procedurals so that one patient may be denied coverage for a certain procedure whereas a second patient may receive coverage for the same medical procedure.

Medical reports are often stored electronically in databases in a variety of computer and computer related hardware. Medical reports containing lexicon (language) that varies significantly causes significant problems with storage and retrieval of such medical reports. Again this can cause problems with health insurers, doctors and others performing medical research, and even patients. Someone attempting to retrieve information from a medical database may either fail to retrieve certain pertinent information, or may retrieve extraneous information. This can cause the databases of patient medical information to be inaccurate leading to inaccurate reports.

Finally, it is extremely important that accurate and consistent medical reports are created quickly. This can not only allow doctors to see more patients, but can also allow patient information to be transferred quicker. This can lead to quicker decisions regarding medical treatment and insurance coverage, which hopefully will lead to a quicker recovery for patients.

There is a need, therefore, in the art to assist doctors and other medical personnel in providing better and more complete descriptions for ease of review and understanding. As well as a need to create such complete descriptions in a timely fashion.

Thus, it would be desirable to provide a method of creating medical reports for patients with standard lexicon regardless of the medical practitioner that enters the information, the transcriptionist entering the information, or even the patient describing his or her ailment. Such medical reports to be created in shorter time.

### SUMMARY OF THE INVENTION

The present invention provides a lexicon system for assisting doctors in preparing reports or notes so that the reports will be complete and easy to understand. The present invention is achieved through a standardization of the lexicon used to explain the interpretation of information. Having such a lexicon developed will significantly increase the productivity of the medical provider, including radiologists, oncologists, psychologists, etc. As more completely shown in the attached description, every interpretation of a specific body part will include standard descriptive language that will clearly and consistently provide information familiar to the referring physician. As such, a doctor's interpretation of the medical information will be recorded utilizing the predetermined medical phrases that have been developed to promote completeness and clarity in reporting results of any study.

The mode of executing the present invention can vary depending upon the technology desired. When integrating the present invention with a computer system, the presently preferred mode of the invention contemplates the utilization of templates to provide doctors with predetermined medical descriptions for explaining results. Therefore, a doctor could point-and-click to the preferred lexicon that best describes the situation so that consistent language is used, even amongst numerous doctors. It is also contemplated that a voice recognition system could also assist the doctor in interacting with the computer system as well as other types of input peripherals (e.g., palm pilot, blackberry, infrared devices, etc.). Other medical staff could also utilize the invention. As such, the lexicon invention therefore provides consistent, concise, and descriptive interpretations in a standard report format to the referring physician, regardless of which radiologist interprets the study.

Therefore, in accordance with the present invention there is provided a method for creating a medical report. The method comprises examining at least one of a patient or test results of a patient, summarizing findings of the examination, having access to previously created phrases describing in greater detail at least one of the summarized finding, choosing at least one of the previously created phrases based upon at least one of the summarized findings, generating a report utilizing the previously created phrases.

### DESCRIPTION OF THE DRAWINGS

Objects and advantages together with the operation of the invention may be better understood by reference to the following detailed description taken in connection with the following illustrations, wherein:

FIG. 1 is a graphical representation of a first embodiment of a method of the present invention;

FIG. 2 is an example of a template of an embodiment of the present invention;

FIG. 3 is graphical representation of a second embodiment of a method of the present invention; and

FIG. 4 is a graphical representation of a third embodiment of a method of the present invention.

### DETAILED DESCRIPTION

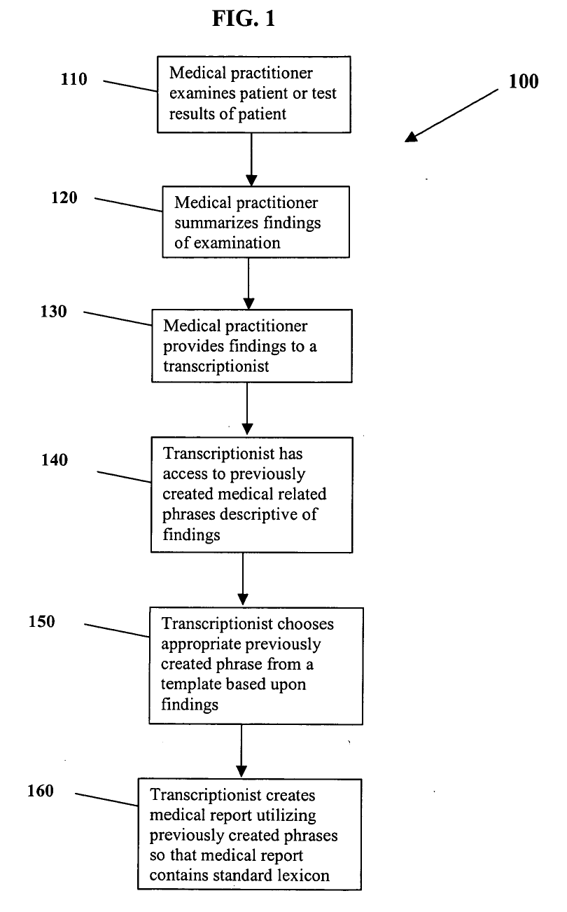

Referring now to FIG. 1 a first embodiment of the method of the present invention is shown. According to this embodiment of the method 100, a medical practitioner, such as a radiologist, oncologist, other physician, or nurse, examines a patient or examines some form of test results of a patient such as x-rays or magnetic imaging resolution (“MRI”) results 110. When the medical practitioner is examining test results of a patient, the medical practitioner may receive such electronically, such as via e-mail, an Internet posting, in the mail, etc. During the examination of the patient or the patient's test results, the medical practitioner evaluates the patient's condition. After or contemporaneously with such examination the medical practitioner will record the results of his or her findings in some sort of summary. Typically these results are memorialized in some form of brief handwritten notes, orally transcribed notes, computer entered notes, or some combination thereof 120. These results form the basis of the patient's medical records and medical history. It is, therefore, essential that such records and history be accurate, complete, and consistent from patient to patient and from medical practitioner to medical practitioner.

Accordingly, once the medical practitioner completes his or her notes of the results of the findings he or she will, according to this embodiment, contact a transcriptionist to complete the medical report. The medical practitioner will provide the notes to the transcriptionist 130. Depending upon how the notes are taken, the medical practitioner may send his or her notes through the mail, e-mail the notes, hand deliver the notes, post the notes on the Internet, or deliver the notes in some other form.

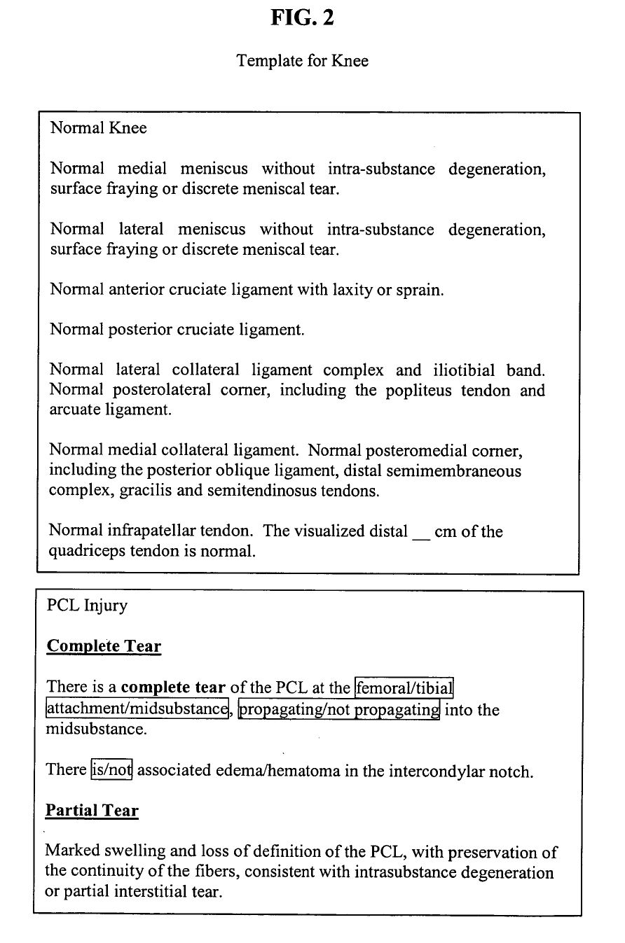

Once the transcriptionist has the notes, the transcriptionist begins to complete the medical record. The transcriptionist will have access to previously created medical related phrases that contain standardized lexicon describe a plurality of possible findings 140. This access could include a template that is a printed document, such as the example shown in FIG. 2. Alternatively, the template may be stored in a computer, such as a standard desktop computer, a laptop computer, or other peripheral input device (such as a palm pilot, blackberry, infrared devices, cell phone, etc.) The transcriptionist will review the summarized findings. Based upon this review, the transcriptionist will choose the appropriate previously created phrase from the template that corresponds to the summarized findings 150. More specifically, the transcriptionist will review the notes and determine with which template he or she should begin. The transcriptionist will review the appropriate template to find the appropriate previously created phrases that correspond to the entry in the notes. The transcriptionist will then choose the appropriate phrases and insert them into the medical report. Once the transcriptionist has gone through the notes in their entirety, he or she will compile the phrases into a medical report for such patient. The medical report will be complete, will contain consistent language, and will be quickly generated.

In this embodiment, a medical practitioner may choose to only summarize portions of the examination and then provide full detail regarding the remaining portion of the examination. For example, the medical practitioner may only summarize normal conditions while providing full details of abnormal results. The transcriptionist will, in this case, use the template to enter normal information while using the full details provided to enter the abnormal information. Alternatively, the medical practitioner may summarize both the normal and abnormal results so that the transcriptionist will use the templates for both normal and abnormal results.

The medical report created will consist of standard medical lexicon so that no matter which medical practitioner examines the patient or which transcriptionist reviews the notes, the lexicon will remain consistent. The medical report will also be accurate and very detailed, while being created in a short amount of time. This will, therefore, permit standard medical reports to be created in a very short amount of time that are complete, detailed, easily read, and manipulated. This will reduce the time needed to create medical reports while at the same time permitting such reports to be accurate, complete, and very detailed.

It should be noted that the phrases used in the template are previously created by a skilled medical practitioner with years of experience. These previously created phrases consist of industry-accepted lexicon. This lexicon has been scrutinized by many different medical practitioner and user of medical reports and determined to be effective. Accordingly, lexicon from any medical field can be used with this invention.

An example of the embodiment above is described below. A medical practitioner, such as a radiologist may examine x-rays of a patient's knee to make a determination of an injury. The medical practitioner may receive the x-rays via e-mail, from a posting on the Internet or an intranet, via the mail, via hand delivery, or some other delivery method. The medical practitioner will review the x-ray and take notes summarizing the findings of such review. These could consist of findings such as “normal medial meniscus, normal lateral meniscus, and normal ACL.” The notes may either be handwritten, or more likely dictated into some sort of recording device. Once the medical practitioner identifies an injury, such as a partial tear of the post cruciate ligament (“PCL”), he or she will add “partial tear of PCL” to the notes. The medical practitioner will then provide such notes onto a transcriptionist. The transcriptionist will then review the notes and begin the creation of the medical report.

As the notes relate to the examination of an x-ray of a knee, the transcriptionist will go to the knee template to which he or she has access, such as the one shown in FIG. 2. The transcriptionist will select “normal medial meniscus, normal lateral meniscus, and normal ACL” from the template, as they correspond to the notes of the medical practitioner and add them to the medical report. The medical report will then have the following previously created phrases inserted therein:
Normal medial meniscus without intra-substance degeneration, surface fraying or discrete meniscal tear. Normal lateral meniscus without intra-substance degeneration, surface fraying or discrete meniscal tear. Normal anterior cruciate ligament with laxity or sprain.
   Depending upon the instructions from the medical practitioner, the transcriptionist may either enter directly the abnormalities found, or use the template to complete to describe the abnormalities. For example, the notes may state “complete tear of PCL at femoral, propagating, and no edema/hematoma.” The transcriptionist would then find this on the template and choose the proper previously created phrases so that the medical report would provide:
There is a complete tear of the PCL at the femoral, propagating into the midsubstance. There is no associated edema/hematoma in the intercondylar notch.
   This, therefore, would lead to a final medical report that is complete, clear, and consistent. It would make no difference if another medical practitioner examined the patient or if another transcriptionist were used, the final medical report would be substantially similar.

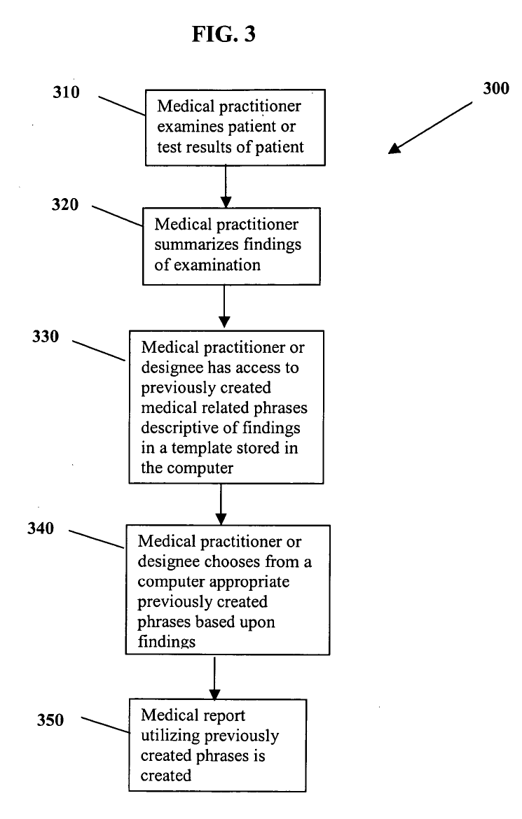

A second embodiment of the method 300 of the present invention is shown in FIG. 3. In this embodiment, a medical practitioner examines a patient or examines test results of a patient, such as x-ray results or MRI results 310. The medical practitioner summarizes the findings in notes or some other system 320. The medical practitioner, or a designee, will then use a computer to create the final medical report. The medical practitioner or designee will have access to previously created phrases from a template stored on the computer 330 that are descriptive of the findings of the medical practitioner. As previously described, these previously created phrases consist of a plurality of alternative descriptions for results of medical examinations in lexicon that is descriptive and consistent.

The medical practitioner will begin by entering some background information about the patient. Then the medical practitioner will choose the proper template with which to choose the appropriate previously created phrases based upon the body part examined. Once the proper template is found, the medical practitioner chooses the appropriate previously created phrase from the template on the computer that corresponds to the findings from the examination 340. The medical practitioner then selects the appropriate phrase and enters it into the report. The medical practitioner will repeat this until all findings have been entered. The medical practitioner then compiles the entries into a medical report. The medical report being complete and contains standard lexicon 350. The medical report can then be outputted to a file or to a printing device.

An example of this second embodiment is below. A medical practitioner may examine some sort of radiological test such as x-rays of a patient's knee to make a determination of an injury. Such x-rays could have been e-mailed to the medical practitioner. The medical practitioner will review the x-ray and will summarize his findings in notes, such as “normal medial meniscus, normal lateral meniscus, and normal ACL.” The medical practitioner may then identify the injury, such as “partial tear of PCL.” The medical practitioner will then enter this information into a computer, such as a normal desktop or laptop, or even some sort of input peripheral such as a PDA, cell phone, etc. Such computer will have access to previously created phrases descriptive of the findings. These previously created forms can be stored in a template that can be stored in the computer or stored in a separate server computer.

More specifically, the medical practitioner will first enter the patient's background information to begin the creation of the report. The medical practitioner will enter the patient's name and the location of the body examination occurred, such as a knee. The template for the knee will then be pulled up on the computer, such as the one shown in FIG. 2. The template containing the previously created phrases may either automatically come up or the medical practitioner may choose such template from a list. The medical practitioner will then select “normal medial meniscus, normal lateral meniscus, and normal ACL” from the template. The following previously created phrases will then be inserted into the medical report:
Normal medial meniscus without intra-substance degeneration, surface fraying or discrete meniscal tear. Normal lateral meniscus without intra-substance degeneration, surface fraying or discrete meniscal tear. Normal anterior cruciate ligament with laxity or sprain.

The medical practitioner will then either enter directly in their own words the abnormalities found, or use the template to enter the abnormalities found. For example, the medical practitioner may look for the previously created phrases for a PCL tear. The medical practitioner need only add some specificity regarding the injury, such as the specific location, and the severity thereof. The medical report will then include the following phraseology:
There is a complete tear of the PCL at the femoral, propagating into the midsubstance. There is no associated edema/hematoma in the intercondylar notch.
   This, therefore, will lead to a final medical report that utilizes the previously created phrases so that it is complete, clear, and consistent. The time to produce such medical report will be drastically reduced. Using the template would allow any medical practitioner to enter the findings and the lexicon of the report would be consistent from user to user.

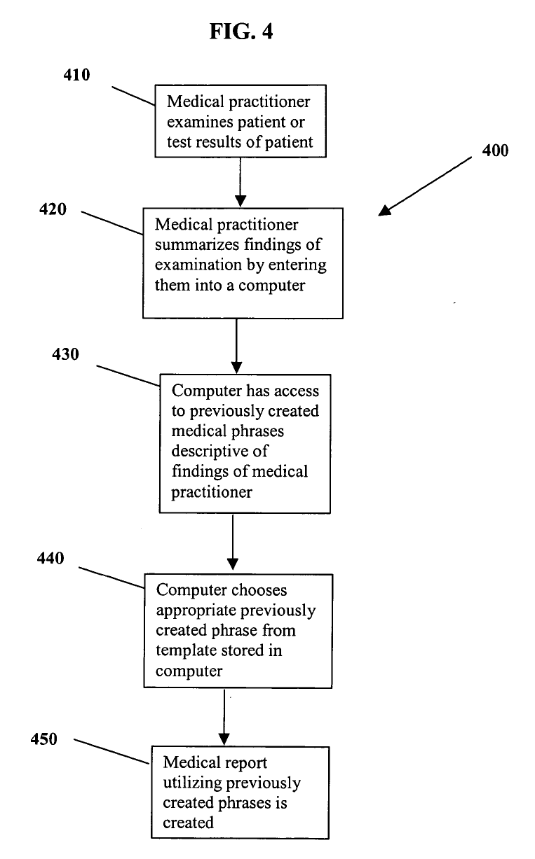

A third embodiment is shown in FIG. 4. In this embodiment, the medical practitioner can easily create the medical report during the examination or immediately thereafter. In this embodiment, the medical practitioner examines a patient or examines radiological test results of a patient, such as x-rays or MRI results 410. Instead to taking notes regarding the findings of the examination as previously done, the medical practitioner will enter the summary directly into a computer 420. This is most easily done using some sort of input peripheral such as a palm pilot, blackberry, infrared devices, cell phone, etc. The computer used has access to previously created medical phrases descriptive of the findings found in a template either stored in it or available to it via a server computer 430. The computer then chooses the appropriate previously created phrase from the template to describe the findings with detail 440. Alternatively, the medical practitioner can choose the appropriate previously created phrase from the template on the computer to describe the findings. The medical practitioner or the computer then enters the appropriate phrase into a report and compiles all of the entries into a final medical report 450. The medical report is complete and will contain standard lexicon and can be outputted to a file or to a printing device.

For example, the medical practitioner may examine x-rays of a patient's knee to make a determination of an injury that are received via e-mail. The medical practitioner will review the x-ray and instead of taking notes on the results of such review, the medical practitioner will use a computer such as an input peripheral to enter the information directly to create the medical report. A PDA is particularly useful because it would permit the medical practitioner to create the standard medical report concurrently with the examination. The medical practitioner may choose the appropriate previously created phrase or phrases that correspond to “normal medial meniscus, normal lateral meniscus, and normal ACL.” The following previously created phrases will then be inserted into the medical report:
Normal medial meniscus without intra-substance degeneration, surface fraying or discrete meniscal tear. Normal lateral meniscus without intra-substance degeneration, surface fraying or discrete meniscal tear. Normal anterior cruciate ligament with laxity or sprain.
   Then, the medical practitioner will identify the injury, such as “partial tear of PCL” from the template. The following entries will then be made into the medical report:
There is a complete tear of the PCL at the femoral, propagating into the midsubstance. There is no associated edema/hematoma in the intercondylar notch.
   The medical report will then contain the previously created phrases that correspond to the examination results. The medical report will have been created in a short amount of time and the lexicon will be consistent regardless of which medical practitioner performs the examination.

In another embodiment, the medical practitioner may use a computer such as an input peripheral to enter information and the computer will select the correct lexicon from a template stored in said computer. In this embodiment, a computer program will ask the medical practitioner a series of questions to determine which previously created phrase or phrases should be entered into the medical report. For example, contemporaneously with examining the patient, the medical practitioner may create the medical report for such examination. So while the medical practitioner is reviewing x-rays of a patient's knee, the computer program will ask “what body part is involved?” The medical practitioner will enter “knee.” This will pull up the templates that relate to knees. The computer program will then ask for information about any potential abnormalities. Then the medical practitioner can either enter wording for the abnormality found or can enter a short summary of the injury and the computer program will automatically select the appropriate previously created phrases from the template. Then the computer program will ask the medical practitioner if the remaining parts of the knee are normal. If the answer is yes, then using the template, the previously created phrases for a normal knee will be selected and entered into the medical report. Finally, the medical report is compiled and outputted to a file or a printing device. The medical report, therefore, will contain standard medical lexicon leading to a consistent report.

In yet another embodiment, the medical report can be automatically generated from entries made by the medical practitioner. This will allow the medical report to be completed contemporaneously with the examination of the patient or the examination of the test results of the patient. In this embodiment, the medical practitioner will examine the patient or test results thereof and then enter a summary of his or her findings into a computer. The findings would most likely be entered as the medical practitioner performs his or her examination. A computer program stored on the computer or stored on a server the computer is connected with will automatically choose the appropriate previously created phrase from a template that is descriptive of the findings. The medical report containing the previously created phrases will then be created.

As means of an example of this embodiment, a medical practitioner may review a patient's x-ray on a computer where such x-rays were received via the Internet. As the medical practitioner is examining the x-ray he or she may take notes of the findings on a file, or may enter the findings directly into the computer. The computer will then compare the findings and will choose the appropriate previously created phrase or phrases that corresponds to the findings. So that for example if the medical practitioner notes a partial PCL tear, he or she may enter this information along with a note that the rest of the knee is normal. The computer program will then go to the knee template and choose the appropriate previously created phrases to include in the medical report.

Instead of entering the information into a computer, the computer may utilize voice recognition software as a means of input. Therefore, the medical practitioner need only talk into the computer. Based upon the results, the computer will choose the appropriate previously created phrases as described above. The voice recognition software will allow a medical practitioner to examine the patient or the patient's record and speak the findings directly into the computer. This would allow the medical report to be created very quickly and with minimal effort. It should be understood that the voice recognition software can also be used with the other embodiments of the present invention disclosed above to enter notes of the examination by the medical practitioner.

The invention has been described above and, obviously, modifications and alternations will occur to others upon a reading and understanding of this specification. In addition, the method described above is not limited to the order in which the steps above are recited. The claims as follows are intended to include all modifications and alterations insofar as they come within the scope of the claims or the equivalent thereof.

1. A method for creating a medical report, said method comprising:
examining at least one of a patient or test results of a patient;
summarizing findings of said examination;
having access to previously created phrases describing in greater detail at least one of said summarized findings;
choosing at least one of said previously created phrases based upon at least one of said summarized findings; and
generating a report utilizing said previously created phrases.

2. The method of claim 1, wherein examining test results of a patient comprises examining radiological test results of said patient.

3. The method of claim 2, wherein examining radiological test results of said patient comprises examining x-rays taken of said patient.

4. The method of claim 2, wherein examining radiological test results of said patient comprises examining magnetic resonance imaging results of said patient.

5. The method of claim 2, further comprising receiving said radiological test results electronically.

6. The method of claim 1, wherein summarizing findings 6f said examination comprises manually taking notes of said findings.

7. The method of claim 1, wherein summarizing findings of said examination comprises entering said findings into a computer.

8. The method of claim 7, wherein entering said findings into said computer comprises speaking into said computer, said computer utilizing voice recognition software.

9. The method of claim 1, wherein said previously created phrases are assembled in a template.

10. The method of claim 9, wherein said template is stored in a computer.

11. The method of claim 9, wherein said template is a printed document.

12. The method of claim 1, wherein choosing at least one of said previously created phrases is manually performed.

13. The method of claim 1, wherein choosing at least one of said previously created phrases in performed automatically by a computer.

14. A method for creating a medical report, said method comprising:
examining a radiological test result of a patient;
summarizing findings of said examination;
having access to previously created phrases describing in greater detail at least one of said summarized findings;
choosing at least one of said previously created phrases based upon at least one of said summarized findings; and
generating a report utilizing said previously created phrases.

15. The method of claim 14, further comprising sending said summary of findings to a transcriptionist.

16. The method of claim 15, wherein said transcriptionist has access to said previously created phrases and chooses at least one of said previously created phrases.

17. A method for creating a medical report, said method comprising:
receiving a radiological test result of a patient electronically;
examining said radiological test result;
summarizing findings of said examination;
having access to previously created phrases describing in greater detail at least one of said summarized findings;
choosing at least one of said previously created phrases based upon at least one of said summarized findings; and
generating a report utilizing said previously created phrases.

18. The method of claim 17, further comprising forwarding said summary of findings electronically to another party.

19. The method of claim 17, further comprising entering said summary of findings into a computer.

20. The method of claim 19, wherein choosing at least one of said previously created phrases is performed by said computer.
